(19) United States
(12) Patent Application Publication
(10) Pub. No.: US 2010/0186775 A1
(43) Pub. Date: Jul. 29, 2010

(54) ROTATING CLEANING SYSTEM

(76) Inventor: Ole T. Madsen, Munroe Falls, OH (US)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/361,926

(22) Filed: Jan. 29, 2009

(51) Int. Cl. B08B 3/02; B08B 9/093

(52) U.S. Cl. 134/22.18; 134/179; 134/167 R; 134/34

(57) ABSTRACT

A cleaning system for food processing equipment is disclosed. An exemplary system includes a supply source of cleaning media, an apparatus including a main housing having a media inlet, media outlet, an internal media travel path defined between the media inlet and the media outlet, and a rotation generating mechanism, wherein rotational speed of the rotation generating mechanism is controllable by pressure flow of the media in the media travel path. A supply line connects the supply source and the media inlet. A rotatable lance secured to the main body media outlet, and has at least one nozzle disposed between the media outlet and a distal end of the lance. The media is sprayed from the at least one nozzle in a rotational path. A method of use is also disclosed. In an exemplary method, operational time, temperature, pressure, rotational speed and media type are controlled to reach target cleanliness levels.

### FIELD OF THE INVENTION

The present invention relates to a system for in-line cleaning of food processing equipment during production downtime.

### BACKGROUND OF THE INVENTION

Manufacturers in many industries, such as food and pharmaceutical processing, need to deal with variations in production flows, including rapid change over from one product to another, while maintaining a high production through-put and insuring that the integrity and quality of the manufactured products meet good manufacturing practice (“GMP”) standards. In order to maintain product integrity and quality, manufacturing equipment must be properly cleaned, especially between product runs.

Historically, food and pharmaceutical manufacturers have relied on traditional clean-in-place (“CIP”) methods and equipment that follow well-known guidelines to utilize technology, designs and philosophies dating back to the dairy industry of the 1950's. Such CIP systems are constructed around multiple vessels (each vessel is dedicated for the cleaning solution, rinse water, etc.) which are typically designed as pressure vessels, since filters are deemed necessary due to sanitary considerations. Other design characteristics of these “dairy-type” CIP systems are the use of flow-control as the principal operating parameter, which is tightly connected to the application of single stage centrifugal pumps that operate with very high flow rates and low pressures. In addition, to the single stage centrifugal pump in the supply, an eductor-type return pump module is commonly used. Cleaning media are applied with static spray balls that have a very poor coverage, and impingement, and cleaning is based upon long cleaning times with high volumes of water and chemicals.

Thus, these “dairy-type” CIP systems are designed to provide high volume/slow pressure cleaning that achieves results (i.e., the removal of product soils) through chemical action and time (“clean-until-clean”), using large holding vessels, single stage centrifugal pumps and static spray balls. Such “dairy-type” CIP systems are limited in flexibility and performance, and cannot utilize the full spectrum of available cleaning parameters, such as time, action (meaning pressure and flow), chemistry, temperature, etc., to enhance cleaning results.

Traditional engineering approaches to CIP systems tend to focus on specifying individual components rather than addressing operational and performance issues and integrating them into the design of a cleaning system as a whole. As a result, they continue to re-invent “dairy-type” CIP systems, using high volume and low pressure, that consume more resources and produce poorer quality cleaning results than could otherwise be achieved.

### SUMMARY OF THE INVENTION

In an illustrated embodiment of the invention, a cleaning system for processing equipment includes a supply source of cleaning media, an apparatus including a main housing having a media inlet, media outlet, an internal media travel path defined between the media inlet and the media outlet, and a rotation generating mechanism. A rotational speed of the rotation generating mechanism is controllable by pressure flow of the media in the media travel path. A supply line connects the supply source and the media inlet. A rotatable lance is secured to the main body media outlet, and has at least one nozzle disposed between the media outlet and a distal end of the lance. The media is sprayed from the at least one nozzle in a rotational path. In an exemplary method, operational time, temperature, rotational speed as a function of pressure, and media type are controlled to reach a target cleanliness level.

Further features and advantages of the invention will become apparent from the following detailed description made with reference to the accompanying drawings.

### BRIEF DESCRIPTION OF THE DRAWINGS

FIG. 1 is a front left perspective view of a portion of a cleaning device constructed in accordance with an embodiment of the present invention, showing a housing of the device;

FIG. 2 is a front right perspective view of the device of FIG. 1, showing a supply line connected at a proximal end of the housing and a rotatable lance positioned on a distal end of the housing;

FIG. 3 is a front view of the device of FIG. 2;

FIG. 4 is a top view of the device of FIG. 2, shown without the supply line in place;

FIG. 5 is a partial cross-sectional view of the device of FIG. 4 shown along the lines 5-5 of FIG. 4, showing structural detail of the rotatable lance and the housing;

FIG. 6 is a rear left perspective view of the device of FIG. 2, showing several spray nozzles installed on the rotatable nozzle;

FIG. 7 is an enlarged perspective view of a spray nozzle installed on the rotatable nozzle;

FIG. 8 is an enlarged perspective view of an alternative spray nozzle installed on the rotatable nozzle;

FIG. 9 is a front view of mounting bracket suitable for providing gravitational support to the housing;

FIG. 10 is a front view of mounting bracket suitable for providing gravitational support to the rotatable lance; and

FIG. 11 is a process flow chart illustrating an embodiment of the present invention.

### DESCRIPTION OF THE INVENTION

The Detailed Description of the Invention merely describes preferred embodiments of the invention and is not intended to limit the scope of the specification or claims in any way. Indeed, the invention as described by the claims is broader than an unlimited by the preferred embodiments, and the terms in the claims have their full ordinary meaning.

The present invention relates to a system for cleaning food processing equipment. In one discussed embodiment, the system is used in the food industry to clean production equipment at the conclusion of production runs, or in between production cycles. An exemplary cleaning system includes a media driven and media lubricated rotating apparatus. The media selected acts as a cleaning fluid and is selected for contact with food.

The inventive cleaning system utilizes and combines the full spectrum of cleaning parameters, including, e.g., time, action, chemistry and temperature, to ensure a successful, robust and validated cleaning process. Rather than relying exclusively on increasing the time, volume of water applied and the chemical concentration of cleaning solutions, the cleaning system advantageously operates with adjustable temperatures and much higher pressures (90 to 225 psi), using mechanical impact from nozzle jets, to achieve enhanced product removal capabilities in the cleaning process. This inventive process permits obtainment of industry standard cleanliness levels with significant improvements over known methods. The inventive cleaning system demonstrates substantial savings in material and labor costs, eliminates or substantially reduces the use of alcohol and detergent, permits in-line monitoring and approval of results, reduces total cleaning times, reduces resource usage and produces consistent, high quality cleaning results.

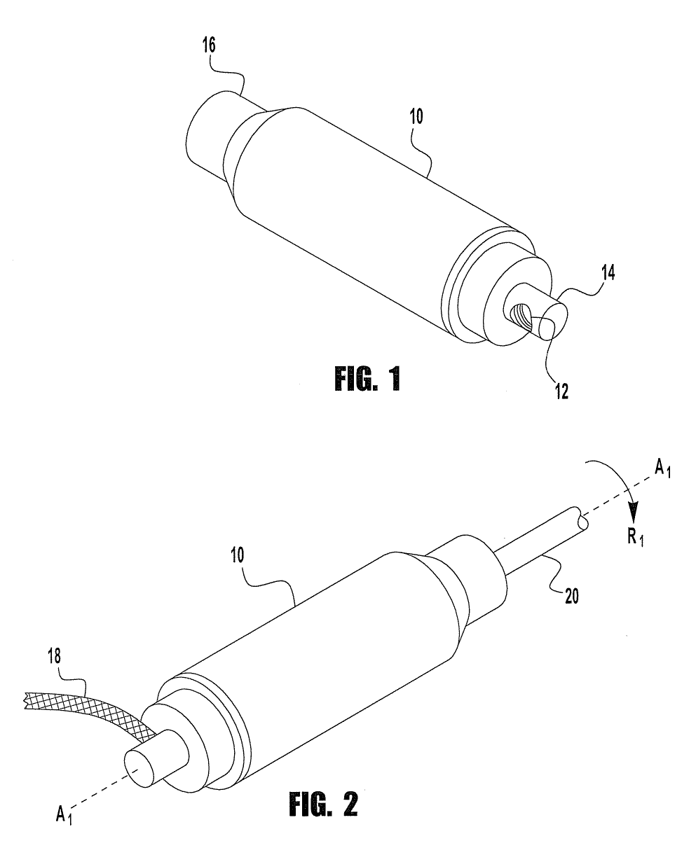

Referring now to the drawings, FIG. 1 illustrates of a portion of a cleaning device constructed in accordance with an embodiment of the present invention. A front left perspective view of a housing 10 is shown. The housing is used to generate rotational movement for the spraying of a media, e.g., a cleaning solution, into a food processing environment. The housing defines an internal travel path (not shown) from a media inlet 12 at a proximal end 14 of the housing to a media outlet (not shown) at a distal end 16 of the housing 10. As shown, the media inlet 12 is a female threaded port, although various designs can be used. The housing 10 contains a self-driven turbine that is rotatable by the passage of pressurized media through the travel path. The housing and its internal parts, e.g., the turbine, are self-lubricating. In other words, media lubricates the moving parts of the turbine such that no lubricating substances, such as for example, oil or grease, are used in operation of the housing. Exemplary housing materials include stainless steel.

In operation of the system, a media is selected that is appropriate for interaction with food and food producing raw materials. The media is used to a clean food processing environment to a standard cleanliness level. In the practice of the present invention, preferably cleaning solution media is compatible over desired lifecycles with a variety of products, such as for example, Stainless Steel AISI 316/316L, SAF2205, FEP/Silicone, PEEK, PVDF and PTFE. The invention advantageously also allows the use of normal detergents, moderate solutions of acids and alkalies, as well as other solvents, a water diluted media. Any or all at may be used at ambient or higher temperatures. The present invention eliminates any requirement for aggressive chemicals, excessive concentrations of chemicals at elevated temperatures, and hydrochlorides.

A front right perspective view of the housing 10 is shown in FIG. 2. The cleaning system includes a supply line 18 connected to the inlet portion 12 of the housing. The proximal end of the housing 10 is shown in FIG. 3 with the supply line 18 in place. The supply line leads to a media source (not shown). Media travels under pressure from the media source through the supply line and into the housing. The supply line may include a filter (not shown), such as for example, a mesh size of 0.01 inch, to avoid particles, scale, or other undesirable materials from clogging the media path within the device.

At the distal end 16 of the housing, a rotatable lance 20 is secured to the media outlet. As shown, the lance 20 and housing 10 are in a co-axial relationship along axis A₁. As discussed, media flow through the housing under pressure turns the self-rotating turbine. The present invention utilizes relatively high pressure, such as for example, 90 to 225 psi, as compared to conventional systems which operate at 35 to 45 psi. In one embodiment, the pressure is generated by a single stage centrifugal pump. In a position to received the pressurized media, the turbine is in physical communication with the proximal end of the lance such that the turbine generates a rotational speed of the lance in a direction R₁. The present invention utilizes relatively low rotational speed, such as for example, 4 to 10 rpm. In the practice of the present invention, the cleaning system may be designed such that the lance 20 rotates in an opposite direction. In one embodiment, the lance rotates a full 360° in operation.

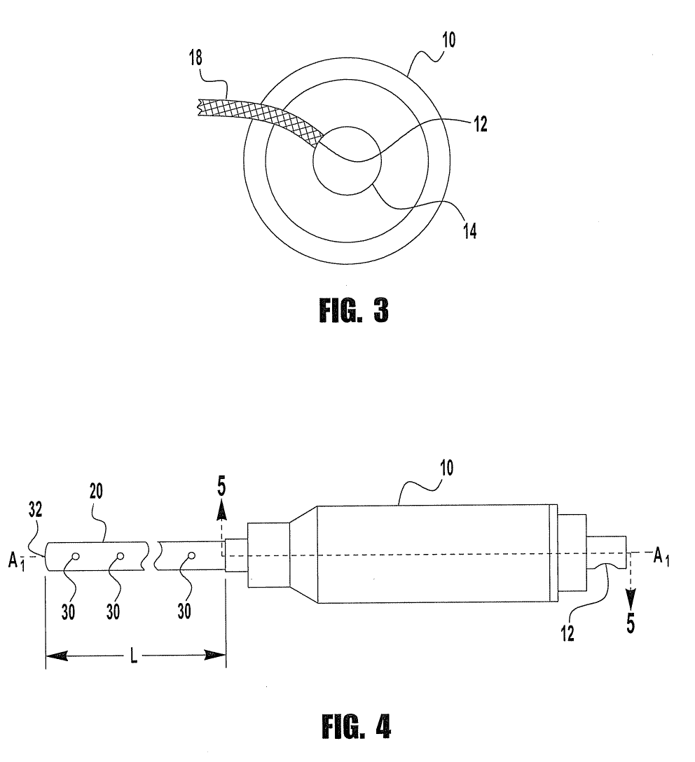

Referring now to FIG. 4, a side view of the cleaning device is shown. The entire length L of the rotatable lance 20 is of a practical length for the application, such as for example, 92 inches, to reach well into a food processing environment, such as for example, an oven. In an embodiment of the invention, one or more devices are mounted within an oven in an horizontal orientation. To be discussed later in greater detail, each device is supported against gravity in a manner to allow the device to expand and contract, i.e., float, within severe temperature ranges. At the end of a production cycle or cycles when the processing equipment requires cleaning, the device is merely activated in the same position in which it is stored during production.

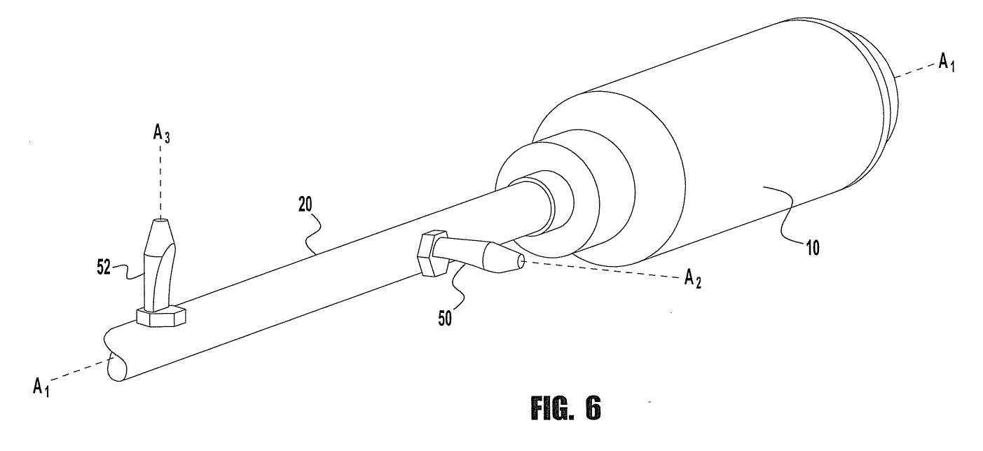

The lance 20 of FIG. 4 is shown with several lance ports 30 and a lance distal end port 32. A lance may have one or more nozzle mounting ports 30. The ports allow for nozzles to be removably secured to the lance. Depending on the performance characteristics required by the environment, a variety of nozzles sizes, spray patterns, and designs may be selected. The lance ports may be equally spaced between a lance proximal end and the lance distal end. The lance ports 30 in FIG. 4 are shown in longitudinal alignment along the length L of the lance 20. In an alternative pattern, a lance port may be located anywhere along the 360° circumference of the lance 20. To be discussed later in greater detail, a variety of lance port circumferential positions are shown in FIG. 6.

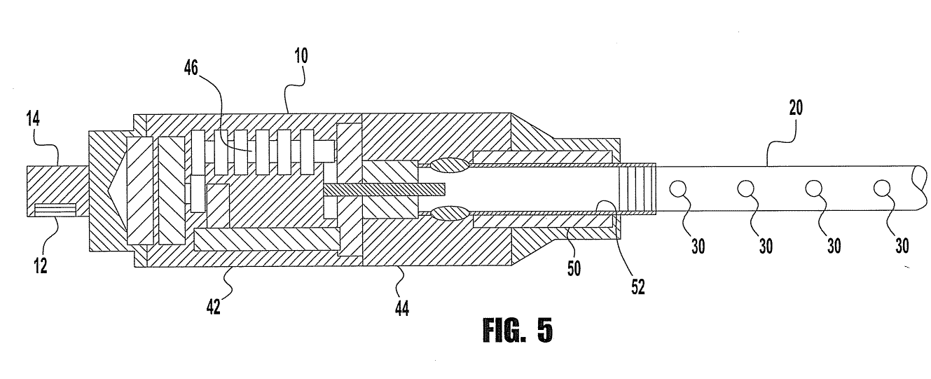

A partial cross-sectional view is shown in FIG. 5, illustrating structural detail of the rotatable lance 20 secured to the housing 10. The housing 10 includes a proximal portion 42, or main housing, and a distal portion 44, or lower housing. Rotation of the lance 20 is initiated by movement of parts within the proximal portion 42. As illustrated, the proximal portion includes a turbine arrangement 46 to be powered and self-lubricated by pressurized flow of the cleaning media. As such, a direct relation exists between rotational speed of the lance 20 and pressure flow in the media path. It should be obvious to others with ordinary skill in the art that other structure within the housing 10 may be utilized to generate rotational movement of the lance 20. A drive spindle 52 is secured at the distal end of the housing 10 to a drive bushing 50. In a threaded or otherwise adequately secured manner, the proximal end of the lance is secured to the drive spindle 52. As illustrated, the lance 20 includes a series of equally spaced nozzle ports 30.

The orientation, design, and type of spray nozzles can vary in the practice of the present invention. Several spray nozzles installed on the rotatable nozzle 20 are illustrated in FIG. 6. A first nozzle 50 extends from the rotatable lance 20 along an axis A₂. As shown, A₂ is perpendicular to the longitudinal axis A₁ of the rotatable lance 20. A second nozzle 52 allows extends from the rotatable lance 20 along an axis A₃ which is perpendicular to the longitudinal axis A₁ of the rotatable lance 20. With respect to the housing 10, the second nozzle 52 is positioned 90° clockwise from the first nozzle 50. In one embodiment, subsequent nozzles are rotated in a similar subsequent pattern as a function of distance or order from the housing 10. The angular difference between nozzles can vary with distance, and can be a different amount than 90°, such as for example, 30° or 45°. The spray pattern of the system is at least in part a function of the number of spray nozzles, the distance of the nozzles apart from each other, and the rotation relation of each nozzle. In one embodiment, a series of successive nozzles are mounted clockwise in relation to a nozzle proximal to the housing 20.

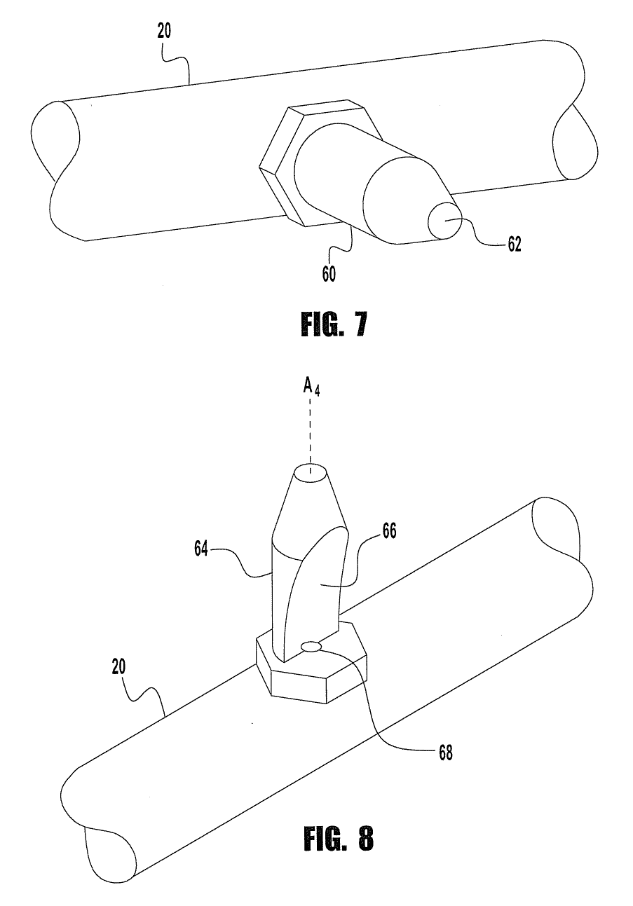

FIGS. 7 and 8 are enlarged perspective views of two exemplary spray nozzles 60, 64. In the practice of the invention, one or more nozzles are removably secured to the rotatable lance such that the nozzles can be installed or changed to meet the particular cleaning requirement of the food processing environment. The nozzle tips are selected specific to environment application, and in some cases, position on the lance.

In FIG. 7, a spray nozzle 60 includes a planar spray surface 62, from which a full cone-shaped is emitted. Spray nozzle 60 may be installed, but not need be, at the lance distal end port 32. An alternative spray nozzle 64 in FIG. 8 produces a different spray pattern as compared to the spray nozzle 60 of FIG. 7. A concave surface 66 of the rotatable nozzle 64 directs spray exiting an orifice 68 in a pattern away from a longitudinal axis A₄ of the nozzle 64. The shape of the concave surface 66 can vary in the practice of the invention. A plurality of spray nozzles with spray control surfaces can be utilized within a food processing environment to improve the performance of the system.

The cleaning device is intended for installation in a horizontal orientation in a food processing environment, such as for example, inside of an oven. Brackets may be used to both secure the cleaning device to the oven, but also to allow the device to expand and contact during the operating temperature cycles within the oven or the cleaning cycle. In some embodiments, the system is arranged to permit expansion and contraction within a food processing oven range of 25 to 325° C.

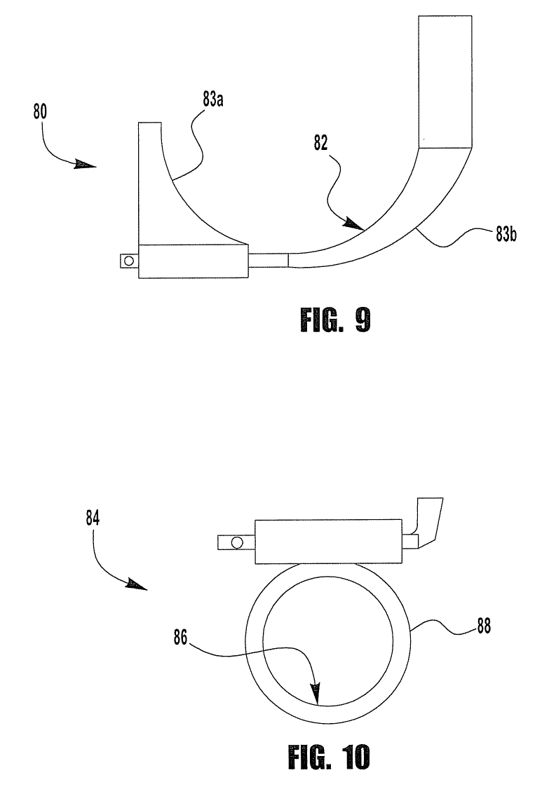

FIG. 9 is a front view of mounting bracket 80 suitable for providing gravitational support to the housing 10. Adjacent or within an oven (not shown), the mounting bracket 80 is secured. A curved surface 82 is correspondingly shaped to receive the housing 20. A radius of several support sections 83a, 83b is equal to or greater than an outer radius of the housing 10. As such, the housing 10 is permitted to have lateral movement as well as expand and contract during operation of the food processing equipment.

An alternative mounting bracket 84 is illustrated in FIG. 10. The mounting bracket 86 is intended for providing gravitational support to the rotatable lance 20 at one of more points distal from the housing 10, and is designed for mounting to the horizontal planar top surface of the oven. An inner diameter of the ring 88 is equal to or greater than an outer diameter of the rotatable lance 20. As such, the lance 20 is permitted to have lateral movement as well as expand and contract during operation of the food processing equipment. Further, the brackets 80, 84 advantageously expedite changing of nozzles after a food processing environment is cleaned and before a production run using different materials is began. As a result, the cleaning system can quickly be re-installed and capable of cleaning the new environment.

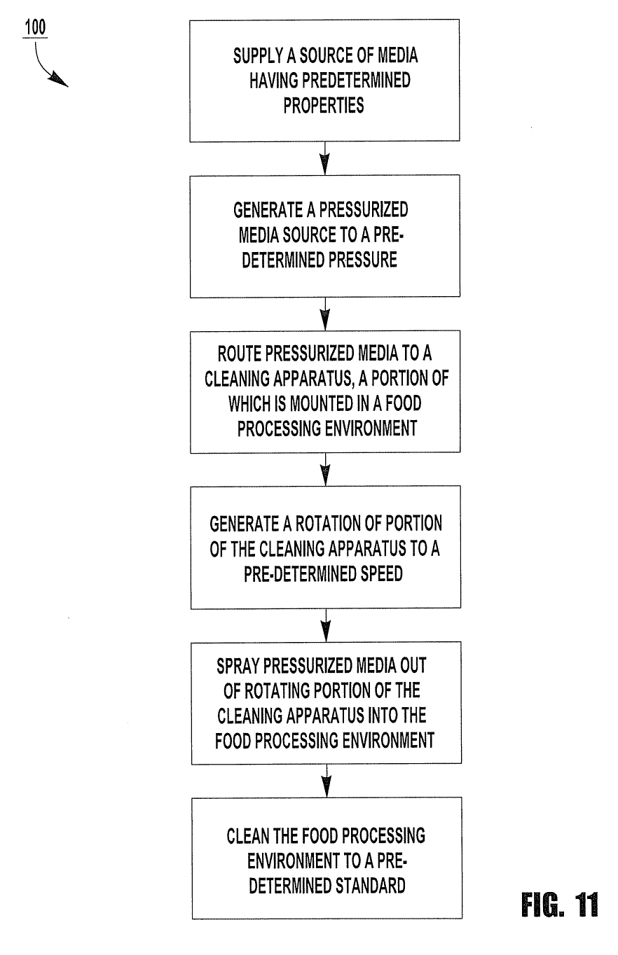

A method for cleaning food processing equipment, such as for example, an oven, will now be discussed. A process flow chart 100 illustrating an embodiment of the present invention is shown in FIG. 11. A source of cleaning media is supplied. The cleaning media is selected in part due to the chemical characteristics of the media in light of the environment in which it will be used. The media may be heated to a temperature, but heating is not required. The media is pressurized by a pump or other suitable means and routed under pressure to a cleaning apparatus. An exemplary cleaning apparatus is illustrated in FIGS. 1-6. The cleaning media flows under pressure through a travel path of a rotational generating mechanism within the cleaning apparatus. The pressurized flow generates rotational movement of a lance attached at a distal end of the cleaning apparatus. The cleaning media is sprayed under pressure into a food processing environment through one or more nozzles removable secured to the lance.

In operation of the present invention, the performance characteristics are a function of one or more factors, including the chemistry of the cleaning media, the cleaning environment temperature, and cleaning media pressure. As such, the operational time can be determined in order to reach a known cleanliness standard, such as for example, and United States Food and Drug Administration standard well-known in the industry. The present invention is capable of meeting standards of many industry standards, such as for example, 21 C.F.R. 11, 21 C.F.R. 210 and 21 C.F.R. 211. The operational time is considerable less then known cleaning processes. The conventional industry processes involve periodic or one time validation of environments after long cleaning cycles. The present invention allows for precise initial design and periodic controllable adjustments of performance characteristics.

Other method steps can be utilized in the practice of this invention. The method may include the set of controlling a rotational speed of the lance by controlling pressure of the media in the media travel path. In one embodiment, the step of spraying the cleaning media under pressure through one nozzle forms a flat cone pattern. Further, the cleaning system may include multiple cleaning apparatus, such that cleaning media under pressure is routed to a plurality of cleaning apparatus located within the same food processing application environment.

While several embodiments of the invention has been illustrated and described, the present invention is not to be considered limited to the precise constructions disclosed. Various adaptations, modifications and uses of the invention may occur to those skilled in the arts to which the invention relates. It is the intention to cover all such adaptations, modifications and uses falling within the scope or spirit of the annexed claims.

What is claimed is:

1. A system for cleaning food processing equipment, the system comprising:
a supply source of cleaning media;
an apparatus comprising a housing having a media inlet, a media outlet, an internal media travel path defined between said media inlet and said media outlet, and a rotation generating mechanism, wherein rotational speed of said rotation generating mechanism is controllable by pressure flow of said media in said media travel path;
a supply line connecting said supply source and said media inlet; and
a rotatable lance secured to said housing media outlet, and having at least one nozzle disposed between said media outlet and a distal end of said lance;
wherein media is sprayed from said at least one nozzle in a rotational path.

2. The system of claim 1 further comprising a mounting arrangement having a planar horizontal surface and at least one hanging bracket, such that said lance is supported by said bracket secured to said surface.

3. The system of claim 1 further comprising an oven and at least one hanging bracket secured to an inside roof surface of said over, wherein said lance is retained by said bracket to support thermally expansion of said lance.

4. The system of claim 1 wherein said rotatable lance is removably secured to said media outlet.

5. The system of claim 1 wherein said at least one nozzle is removably secured to said lance.

6. The system of claim 1 wherein said lance comprises a plurality of nozzle mounting ports.

7. The system of claim 6 wherein a plurality of nozzles are removably secured to said plurality of nozzle mounting ports, and said plurality of nozzles vary in structure.

8. The system of claim 1 wherein said lance is rotatable 360°.

9. The system of claim 1 wherein a direction relationship exists between rotational speed of said lance and pressure flow in said media path.

10. The system of claim 1 wherein said rotational generating mechanism is a turbine arrangement secured within said housing and configured to be powered and lubricated by a flow of said cleaning media.

11. A method for cleaning a food processing environment comprising:
supplying a source of cleaning media;
generating a pressuring flow of said cleaning media;
flowing said cleaning media under pressure to a cleaning apparatus, said apparatus comprising a main body having a media inlet, a media outlet, a media travel path defined between said media inlet and said media outlet, a rotation generating mechanism, and a rotatable lance secured to said main body media outlet, said lance having at least one nozzle disposed between said media outlet and a distal end of said lance;
flowing said cleaning media under pressure through said travel path of said rotational generating mechanism;
generating rotational movement of said lance; and
spraying said cleaning media under pressure through said at least one nozzle into a food processing environment.

12. The method of claim 11 further comprising controlling a rotational speed of said lance by controlling pressure of said media in said media travel path.

13. The method of claim 11 wherein said pressurized flow is 90 to 225 psi.

14. The method of claim 11 wherein a rotational speed of said lance is 4 to 10 rpm.

15. The method of claim 11 wherein the step of spraying said cleaning media under pressure through said at least one nozzle is done within a heated environment.

16. The method of claim 11 wherein said environment is a food processing oven heated to a range of 25 to 325° C.

17. The method of claim 11 comprising flowing said cleaning media under pressure to a plurality of cleaning apparatus located within the same food processing environment.

18. The method of claim 11 wherein the step of spraying said cleaning media under pressure through said at least one nozzle forms a flat cone pattern.

19. The method of claim 11 wherein the step of generating rotational movement of said lance causes 360° movement of the lance.

20. The method of claim 11 wherein a time to reach a known cleanliness standard with said food processing environment is predictable as a function of cleaning media chemistry, cleaning media pressure, and food processing environment temperature.
